(19) United States
(12) Patent Application Publication
(10) Pub. No.: US 2024/0211320 A1
(43) Pub. Date: Jun. 27, 2024

(54) METHOD AND SYSTEM OF OPTIMIZING DEPLOYMENT OF RESOURCES ON CLOUD PROVIDERS

(71) Applicant: HCL Technologies Limited, New Delhi (IN)

(72) Inventors: SREEBANRAJ RAMASAMY, Chennai (IN); HAREENDRAN M, Chennai (IN); MAHESWARI V.S, Chennai (IN)

(21) Appl. No.: 18/544,526

(22) Filed: Dec. 19, 2023

(30) Foreign Application Priority Data
Dec. 22, 2022 (IN) 202211074597

(51) Int. Cl. G06F 9/50

(52) U.S. Cl. CPC G06F 9/5083

(57) ABSTRACT

A method of optimized deployment of resources on cloud providers is disclosed. The method includes determining an inter-relationship score for a relationship of each of a plurality of resources with each of remaining of the plurality of resources, and creating one or more logical clusters of resources, by clustering together resources based on the inter-relationship score for relationship of each of the plurality of resources with each of remaining of the plurality of resources. The method further includes determining a plurality of deployment option scores corresponding to a plurality of deployment options and a plurality of cloud providers, and selecting a cloud provider and a deployment option, based on the plurality of deployment option scores, for each logical cluster of the plurality of logical clusters.

### TECHNICAL FIELD

This disclosure relates generally to resource deployment, and more particularly to method and system for optimized deployment of resources on multiple cloud providers.

### BACKGROUND

Cloud computing offers various advantages for modern business practices. Although, there has been a significant shift toward adoption of cloud computing, however, a good number of workloads are yet to be moved to cloud computing. One problem that is generally faced at the time of using cloud services or migrating to cloud services is that the environment is set up without proper analysis on the resources to be consumed (i.e. a corresponding replica of the existing environment is not created in the cloud environment). This process requires high expenditure but still may not be able to utilize the capability of cloud computing.

In order to avoid such kind of wastage, be cost effective, and maximize the utilization of cloud computing capabilities, proper analysis of the requirements is required. Further, there is a need for careful planning before proceeding anything on the cloud. However, this is met with a challenge that vast knowledge of cloud environments is needed across providers. Further, there are various challenges in deciding the right combination of deployment options and cloud providers for a workload, because of diversity of the characteristics of the resources/components associated with the workload, different levels of interrelationship of the resources/components of the workload, a variety of deployment options available, a variety of services/supports available with cloud providers, and multiple business constraints or priorities like time, cost, etc.

Therefore, there is a need for techniques for selecting right target deployment combination for a workload, through multi-level, multi-dimensional, and recursive analysis while taking into consideration business constraints and technical characteristics.

### SUMMARY

In an embodiment, a method of optimized deployment of resources on cloud providers is disclosed. The method may include determining an inter-relationship score for a relationship of each of a plurality of resources with each of remaining of the plurality of resources, based on attributes associated with each of the plurality of resources. The method may further include creating one or more logical clusters of resources, by clustering together resources based on the inter-relationship score for relationship of each of the plurality of resources with each of remaining of the plurality of resources. Each of the one or more logical clusters may include a set of resources of the plurality of resources. The method may further include, for a logical cluster of the plurality of logical clusters, determining a plurality of deployment option scores corresponding to a plurality of deployment options and a plurality of cloud providers. The deployment option score may be indicative of a feasibility of deploying the logical cluster on a cloud provider of the plurality of cloud providers using a deployment option of the plurality of deployment options. The method may further include, based on the plurality of deployment option scores, for each logical cluster of the plurality of logical clusters, selecting: a cloud provider from the plurality of cloud providers on which the logical cluster is deployed, and a deployment option from the plurality of deployment options using which the logical cluster is deployed.

In another embodiment, a system for optimized deployment of resources on cloud providers is disclosed. The system includes a processor and a memory. The memory stores a plurality of processor-executable instructions, which upon execution, cause the processor to determine an inter-relationship score for a relationship of each of a plurality of resources with each of remaining of the plurality of resources, based on attributes associated with each of the plurality of resources. The processor-executable instructions further cause the processor to create one or more logical clusters of resources, by clustering together resources based on the inter-relationship score for relationship of each of the plurality of resources with each of remaining of the plurality of resources. Each of the one or more logical clusters may include a set of resources of the plurality of resources. The processor-executable instructions further cause the processor to, for a logical cluster of the plurality of logical clusters, determine a plurality of deployment option scores corresponding to a plurality of deployment options and a plurality of cloud providers. The deployment option score may be indicative of a feasibility of deploying the logical cluster on a cloud provider of the plurality of cloud providers using a deployment option of the plurality of deployment options. The processor-executable instructions further cause the processor to, based on the plurality of deployment option scores, for each logical cluster of the plurality of logical clusters, select: a cloud provider from the plurality of cloud providers on which the logical cluster is deployed, and a deployment option from the plurality of deployment options using which the logical cluster is deployed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for optimized deployment of resources on cloud providers, in accordance with some embodiments of the present disclosure.

FIG. 2 illustrates a resource deploying device showing one or more modules, in accordance with some embodiments.

FIG. 3 is a flowchart of a method of optimized deployment of resources on cloud providers, in accordance with some embodiments.

FIG. 4 is a flowchart of determining plurality of deployment option scores for a workload grouping of the plurality of workload groupings, in accordance with some embodiments.

FIG. 5 is a flowchart of a method of determining the plurality of deployment option scores for a logical cluster of the plurality of logical clusters, in accordance with some embodiments.

FIG. 6 is a flowchart of a method of determining the plurality of deployment option scores for a workload grouping of the plurality of workload groupings, in accordance with some embodiments.

FIG. 7 illustrates a Table showing inter-relationship scores for a relationship of each of a plurality of resources with each of remaining of the plurality of resources, in accordance with some exemplary embodiments.

FIG. 8 is a schematic representation of multiple logical clusters created from the resources, based on the inter-relationship scores, in accordance with some exemplary embodiments.

FIG. 9 depicts a Table which includes scores with respect to logical clusters (LC) and deployment options (DO), in accordance with some exemplary embodiments. The

FIG. 10 depicts a Table which includes scores of a combination of logical clusters and deployment options (LC-DO) with respect to cloud providers (CP), in accordance with some exemplary embodiments.

FIG. 11 depicts a Table which includes scores with respect to deployment options (DO) and cloud providers (CP) against a cost factor, in accordance with some exemplary embodiments.

FIG. 12 depicts a Table which includes scores with respect to deployment options (DO) and cloud providers (CP) against a time factor, in accordance with some exemplary embodiments.

FIG. 13 depicts a Table which includes scores of combinations of logical clusters and deployment options (LC-DO) with respect to cloud providers (CP) against cost factor, in accordance with some exemplary embodiments.

FIG. 14 depicts a Table which includes scores of combinations of logical clusters and deployment options (LC-DO) with respect to cloud providers (CP) against time factor, in accordance with some exemplary embodiments.

FIG. 15 depicts a Table which includes scores with respect to logical clusters (LC) and non-functional requirements (NFR), in accordance with some exemplary embodiments.

FIG. 16 depicts a Table which includes scores with respect to NFRs and cloud providers (CP), in accordance with some exemplary embodiments.

FIG. 17 depicts a Table which includes scores with respect to NFRs and CPs against a cost factor, in accordance with some exemplary embodiments.

FIG. 18 depicts a Table which includes scores with respect to NFRs and CPs against a time factor, in accordance with some exemplary embodiments.

FIG. 19 depicts a Table which includes scores with respect to LCs, the CPs, and the NFRs against the cost factor, in accordance with some exemplary embodiments.

FIG. 20 depicts a Table which includes scores with respect to LCs, the CPs, and the NFRs against the time factor, in accordance with some exemplary embodiments.

FIG. 21 depicts an exemplary process of calculating the cost score for LC in CP based on the mathematical product of the deployment score for cloud provider against cost factor and scores with respect to a LC, a CP, and a NFR against the cost factor, in accordance with some exemplary embodiments.

FIG. 22 depicts an exemplary process of the calculating the time score for LC in CP based on the mathematical product of the deployment score for cloud provider against time factor and scores with respect to a LC, a CP, and a NFR against the time factor, in accordance with some exemplary embodiments.

FIG. 23 depicts a process of calculating the final score with respect to logical cluster and deployment option against a cloud provider, in accordance with some exemplary embodiments.

FIG. 24 depicts a process of calculation of cost-factored deployment option scores associated with a workload grouping 1, in accordance with some exemplary embodiments.

FIG. 25 depicts a process of calculation of cost-factored deployment option scores associated with a workload grouping 2, in accordance with some exemplary embodiments.

FIG. 26 depicts a process of calculation of time-factored deployment option scores associated with the workload grouping 1 (WLG 1), in accordance with some exemplary embodiments.

FIG. 27 depicts a process of calculation of time-factored deployment option scores associated with the workload grouping 2 (WLG 2), in accordance with some exemplary embodiments.

FIG. 28 depicts a process of calculating the final score with respect to workload grouping and deployment option against a cloud provider, in accordance with some exemplary embodiments.

FIG. 29 is a schematic representation of a process of deploying resources on a single cloud environment, in accordance with some exemplary embodiments.

FIG. 30 is a schematic representation of a process of deploying resources on multi cloud environment, in accordance with some exemplary embodiments.

FIG. 31 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

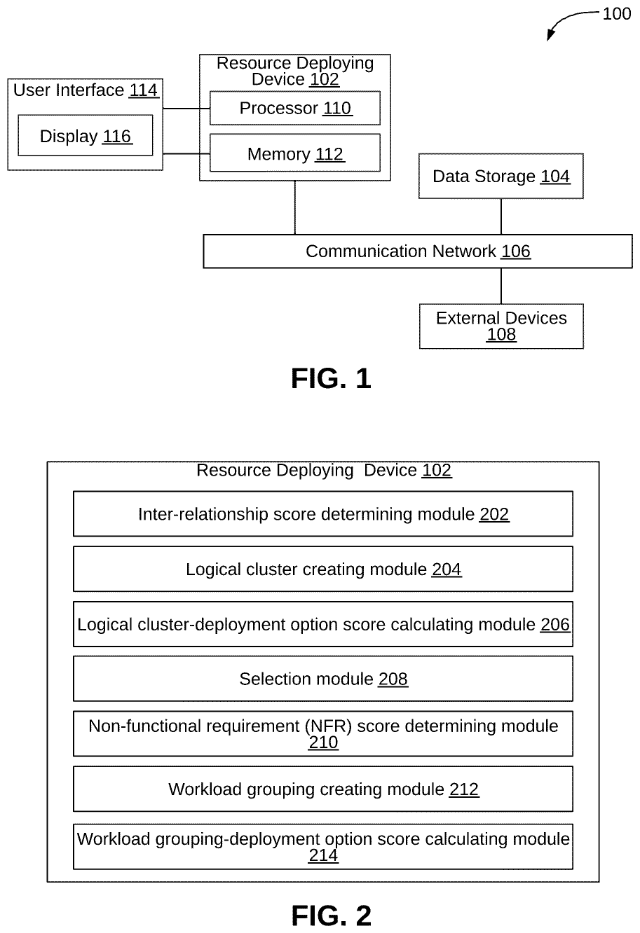

Referring now to FIG. 1, a block diagram of an exemplary system 100 for optimized deployment of resources on cloud providers is illustrated, in accordance with some embodiments of the present disclosure. The system 100 may implement a resource deploying device 102. Further, the system 100 may include a data storage 104. The resource deploying device 102 may be a computing device having data processing capability. In particular, the resource deploying device 102 may have the capability for optimizing deployment of resources on a plurality of cloud providers. Examples of the resource deploying device 102 may include, but are not limited to a desktop, a laptop, a notebook, a netbook, a tablet, a smartphone, a mobile phone, an application server, a web server, or the like.

Additionally, the resource deploying device 102 may be communicatively coupled to an external device 108 for sending and receiving various data. Examples of the external device 108 may include, but are not limited to, a remote server, digital devices, and a computer system. The resource deploying device 102 may connect to the external device 108 over a communication network 106. The resource deploying device 102 may connect to external device 108 via a wired connection, for example via Universal Serial Bus (USB). A computing device, a smartphone, a mobile device, a laptop, a smartwatch, a personal digital assistant (PDA), an e-reader, and a tablet are all examples of external devices 108.

The resource deploying device 102 may be configured to perform one or more functionalities that may include determining an inter-relationship score for a relationship of each of a plurality of resources with each of remaining of the plurality of resources, based on attributes associated with each of the plurality of resources. The one or more functionalities may further include creating one or more logical clusters of resources, by clustering together resources based on the inter-relationship score for relationship of each of the plurality of resources with each of remaining of the plurality of resources, each of the one or more logical clusters comprising a set of resources of the plurality of resources. The one or more functionalities may further include, for a logical cluster of the plurality of logical clusters, determining a plurality of deployment option scores corresponding to a plurality of deployment options and a plurality of cloud providers. The deployment option score may be indicative of a feasibility of deploying the logical cluster on a cloud provider of the plurality of cloud providers using a deployment option of the plurality of deployment options. The one or more functionalities may further include, based on the plurality of deployment option scores, for each logical cluster of the plurality of logical clusters, selecting: a cloud provider from the plurality of cloud providers on which the logical cluster is deployed and a deployment option from the plurality of deployment options using which the logical cluster is deployed.

To perform the above functionalities, the resource deploying device 102 may include a processor 110 and a memory 112. The memory 112 may be communicatively coupled to the processor 110, and stores a plurality of instructions, which upon execution by the processor 110, cause the processor to perform the above functionalities. Further, the resource deploying device 102 may implement a user interface 114, that may further implement a display 116. Examples may include, but are not limited to a touch-based display, a keypad, a microphone, audio speakers, a vibrating motor, LED lights, etc. The user interface 114 may receive input from a user and also display an output of the computation performed by the resource deploying device 102.

Referring now to FIG. 2, a block diagram of the resource deploying device 102 showing one or more modules is illustrated, in accordance with some embodiments. In some embodiments, the resource deploying device 102 may include an inter-relationship score determining module 202, a logical cluster creating module 204, a logical cluster-deployment option score calculating module 206, a selection module 208, a non-functional requirement (NFR) score determining module 210, a workload grouping creating module 212, and a workload grouping-deployment option score calculating module 214.

The inter-relationship score determining module 202 may be configured to determine an inter-relationship score for a relationship of each of a plurality of resources with each of remaining of the plurality of resources, based on attributes associated with each of the plurality of resources. The logical cluster creating module 204 may be configured to create one or more logical clusters of resources, by clustering together resources based on the inter-relationship score for relationship of each of the plurality of resources with each of remaining of the plurality of resources. Each of the one or more logical clusters may include a set of resources of the plurality of resources. For example, the plurality of deployment options may include a virtual machine (VM) deployment, a container deployment, a Kubernetes deployment, a Managed Service deployment, and a Serverless deployment. The plurality of resources may include a runtime, a server, a RDBMS, a NoSQL, a dashboarding, and a service.

The logical cluster-deployment option score calculating module 206 may determine a plurality of deployment option scores corresponding to a plurality of deployment options and a plurality of cloud providers, for a logical cluster of the plurality of logical clusters. The deployment option score may be indicative of a feasibility of deploying the logical cluster on a cloud provider of the plurality of cloud providers using a deployment option of the plurality of deployment options. To determine the plurality of deployment option scores for a logical cluster of the plurality of logical clusters, the logical cluster-deployment option score calculating module 206 may determine a plurality of cost-factored deployment option scores corresponding to a plurality of combinations of the plurality of deployment options, the plurality of cloud providers, and an associated cost of deployment. The cost-factored deployment option may be indicative of a cost-feasibility of deploying the logical cluster on a cloud provider of the plurality of cloud providers using a deployment option of the plurality of deployment options. The logical cluster-deployment option score calculating module 206 may further determine a plurality of time-factored deployment option scores corresponding to a plurality of combinations of the plurality of deployment options, the plurality of cloud providers, and an associated time of deployment. The time-factored deployment option may be indicative of a time-feasibility of deploying the logical cluster on a cloud provider of the plurality of cloud providers using a deployment option of the plurality of deployment options. The logical cluster-deployment option score calculating module 206 may determine the plurality of deployment option scores based on the plurality of cost-factored deployment option scores and the plurality of time-factored deployment option scores.

The non-functional requirement (NFR) score determining module 210 may determine a plurality of non-functional requirements scores corresponding to a plurality of combinations of a plurality of non-functional requirements and the plurality of cloud providers, for a logical cluster of the plurality of logical clusters. The non-functional requirements score may be indicative of a feasibility of deploying the logical cluster on a cloud provider of the cloud providers based on a non-functional requirement of the plurality of non-functional requirements. For example, the plurality of non-functional requirements may include a scalability requirement, a security requirement, an availability requirement, a reliability requirement, a performance requirement, a monitoring-and-alerting requirement.

The selection module 208 may be configured to select a cloud provider from the plurality of cloud providers on which the logical cluster is deployed and select a deployment option from the plurality of deployment options using which the logical cluster is deployed. Further, in some embodiments, the selection module 208 may be configured to select a cloud provider from the plurality of cloud providers on which the logical cluster is deployed, select a deployment option from the plurality of deployment options using which the logical cluster is deployed, and select a non-functional requirement from the plurality of non-functional requirements using which the logical cluster is deployed. In some embodiments, the selection module 208 may further select a plurality of combinations of a cloud provider from the plurality of cloud providers and a deployment option from the plurality of deployment options, on which the logical cluster is deployed.

The workload grouping creating module 212 may create a plurality of workload groupings, by grouping together unique combinations of logical clusters of the one or more logical clusters. The workload grouping-deployment option score calculating module 214 may determine a plurality of deployment option scores corresponding to a plurality of combinations of the plurality of deployment options and the plurality of cloud providers, for a workload grouping of the plurality of workload groupings. This deployment option score may be indicative of a feasibility of deploying the workload grouping on a cloud provider of the plurality of cloud providers using a deployment option of the plurality of deployment options.

To determine the plurality of deployment option scores for a workload grouping of the plurality of workload groupings, the workload grouping-deployment option score calculating module 214 may determine a plurality of cost-factored deployment option scores corresponding to a plurality of deployment options, a plurality of cloud providers, and an associated cost of deployment. The cost-factored deployment option may be indicative of a cost-feasibility of deploying the workload grouping on a cloud provider of the plurality of cloud providers using a deployment option of the plurality of deployment options. The workload grouping-deployment option score calculating module 214 may further determine a plurality of time-factored deployment option scores corresponding to a plurality of deployment options, a plurality of cloud providers, and an associated time of deployment. The time-factored deployment option may be indicative of a time-feasibility of deploying the workload grouping on a cloud provider of the plurality of cloud providers using a deployment option of the plurality of deployment options. The workload grouping-deployment option score calculating module 214 may further determine the plurality of deployment option scores based on the plurality of cost-factored deployment option scores and the plurality of time-factored deployment option scores.

As such, the selection module may be further configured to select a cloud provider from the plurality of cloud providers on which the workload grouping is deployed and select a deployment option from the plurality of deployment options using which the workload grouping is deployed.

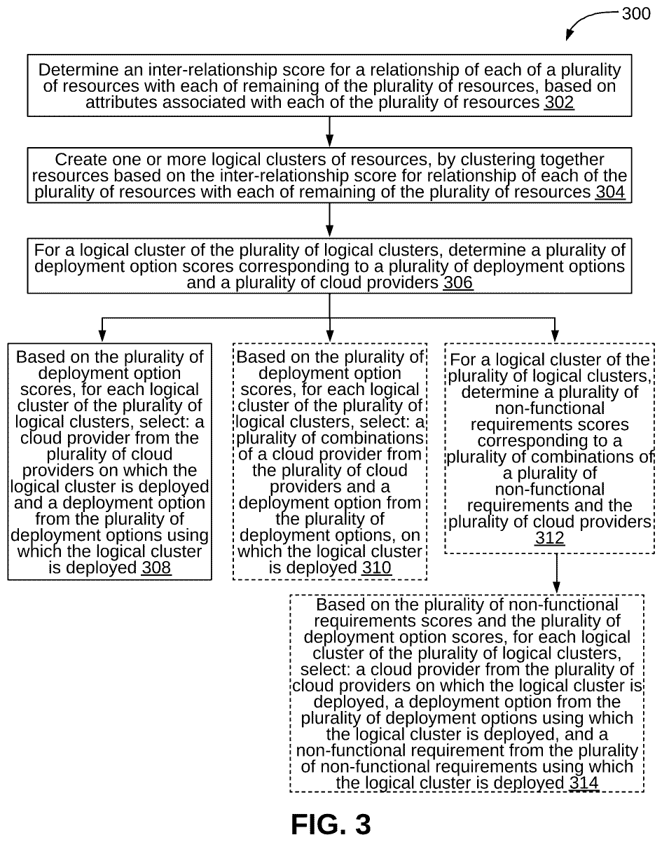

Referring now to FIG. 3, a flowchart of a method 300 of optimized deployment of resources on cloud providers is illustrated, in accordance with some embodiments. For example, the method 300 may be performed by the resource deploying device 102, as discussed above.

The present disclosure provides for methods and systems for optimized deployment of resources on cloud multiple providers. In particular, the present disclosure is directed at generating recommendations for ideal target environment for existing or reference environment by considering business context factors and using custom multi-dimensional artificial-intelligence (AI) model. The reference or source environments may include on-prem (i.e. installed on a local computer system premises), a public cloud, a private cloud, or a hybrid thereof. The term resource may be defined as an entity which can be handled separately in the same computing system or in different computing systems. The business context factors may include cost optimization, time, performance, scalability, reliability, availability, and security. The target environment may include single cloud provider or multiple cloud providers on which the resources may be deployed.

In order to generate recommendations for optimized deployment of the resources on cloud providers, an analysis of existing environment is performed to identify various details about the resources. The analysis may be performed using a custom multi-dimensional artificial intelligence (AI) model on top of collected information against cloud providers. As such, the existing environment, which could be on-prem or a cloud server, may be examined and required data points may be collected. The data points may be processed and analyzed deeply by the custom AI model to generate insights of the existing environment, such as inventory details and dependency matrices between resources. Once the inventory and dependency matrix reports are finalized, these are passed to the multi-dimensional custom AI model to perform further analysis against different cloud providers to generate ideal target deployment recommendations.

This custom AI model may be based on various models created with information about various cloud provides with multi dimension aspects of each service. These models are retrained at regular intervals or when a potential change identified for a cloud provider in market to provide accurate recommendations. The AI model identifies logical clusters and workload group based on the dependencies and performs scoring for cost factor and time factor to identify their target environment.

On completion of the multi-dimensional analysis, a recommendation report may be prepared which may include details of scoring for each deployment combination identified against multiple cloud providers. Further, the report may include ranking of the cloud provider recommendations, based on the associated score. For deployment on a single cloud, workload grouping is relied upon. For deployment on multiple clouds, logical clusters are used.

As part of the analysis, the details resources of source environments, such as infra details, servers, databases, and complete inventory of resources deployed may be identified. In addition, the dependencies matrix between resources are also identified based on custom algorithm. For example, system-level resources may include operating system (OS), central processing unit (CPU), memory, disk space and configuration, network and security, and system processes and services. It should be noted that each resource may be defined by one or more properties which may include name, version, type, requirements, compatibility, dependencies, etc.

An inventory report may be generated by collecting audit logs to identify the load of workloads, and utilization of the processor and memory, and other information required to define non-functional requirement aspects. The inventory report may further include additional packages used by workloads like jar filed, pip libraries, and NPM libraries. The details in the inventory report may be grouped into different categories like hardware, OS, system utilities, runtime environments, dependency tools, workloads, and other services.

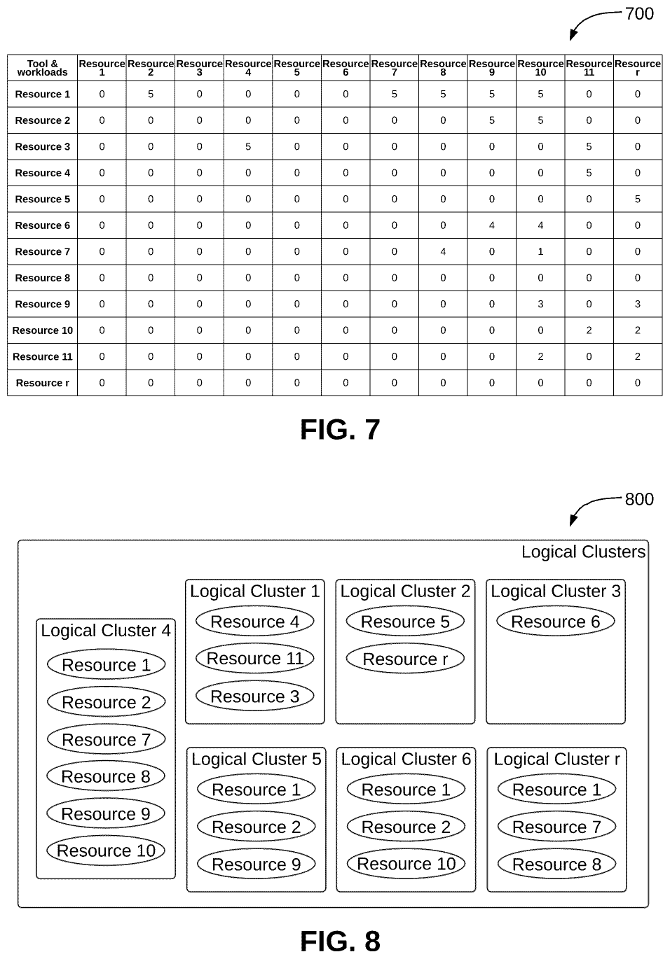

At step 302, an inter-relationship score for a relationship of each of a plurality of resources with each of remaining of the plurality of resources is determined. For example, the inter-relationship score may be determined, based on attributes associated with each of the plurality of resources. Using the details identified in the inventory report, a dependency matrix may be prepared for the resources, as is illustrated in Table 700 via FIG. 7. FIG. 7 illustrates the Table 700 showing inter-relationship scores for a relationship of each of a plurality of resources with each of remaining of the plurality of resources. In other words, the inter-relationship scores indicate dependency of a resource associated with one system (shown in the horizontal header) with a resource associated with another system (shown in the vertical header). For example, an inter-relationship scores for a relationship of a resource-1 of the vertical header with a resource-2 of the horizontal header is “5”, an inter-relationship scores for a relationship of the resource-1 of the vertical header with a resource-3 of the horizontal header is “0”, and so on. As mentioned above, the resources may be of any type of the below types: Runtime (for example, Java, Python, Node JS, etc.), Server (for example, Tomcat, Flask, Apache, etc.), Relational Database Management System (RDBMS) (for example, MySQL, Postgres, SQL Server, etc.), Non-Structured Query Language (NoSQL) (for example, Mongo DB, ES, etc.), Dashboarding (for example, Kibana, etc.), and Services (for example, Micro service, Monolith etc.).

At step 304, one or more logical clusters of resources may be created, by clustering together resources based on the inter-relationship score for relationship of each of the plurality of resources with each of remaining of the plurality of resources. Each of the one or more logical clusters may include a set of resources of the plurality of resources. As such, a logical cluster (LC) may be a grouping of service or tools with runtime and server required which could be deployed in a separate environment. A schematic representation 800 of multiple logical clusters created from the resources, based on the inter-relationship scores (as described in conjunction with FIG. 6) is illustrated in FIG. 8. As shown in FIG. 8, based on the inter-relationship scores,
a logical cluster-1 is created by clustering together resources 4, 11, 3;
a logical cluster-2 is created by clustering together resources 5, r;
a logical cluster-3 is created from resource 6;
a logical cluster-4 is created by clustering together resources 1, 2, 7, 8, 9, 10;
a logical cluster-5 is created by clustering together resources 1, 2, 9;
a logical cluster-6 is created by clustering together resources 1, 2, 10; and
a logical cluster-7 is created by clustering together resources 1, 7, 8.

Each of the logical clusters may be assessed for different possible deployment options (DO) and non-functional requirements (NFR) against different cloud providers with a score based on the need and applicability. For example, the deployment options may include virtual machine (VM), container, Kubernetes, managed service, serverless, etc. the non-functional requirements may include scalability, security, availability, reliability, performance, monitoring and alerting, etc. Further, as will be explained in the subsequent sections of this disclosure, the deployment option and non-functional requirements may be assessed with factors of cost and time. The cost factor may signify a cost optimized recommendation, where it could take extra time to setup every required item in the cloud. The time factor may signify a quick cloud movement with shortest time span, however, the same may cost more than required.

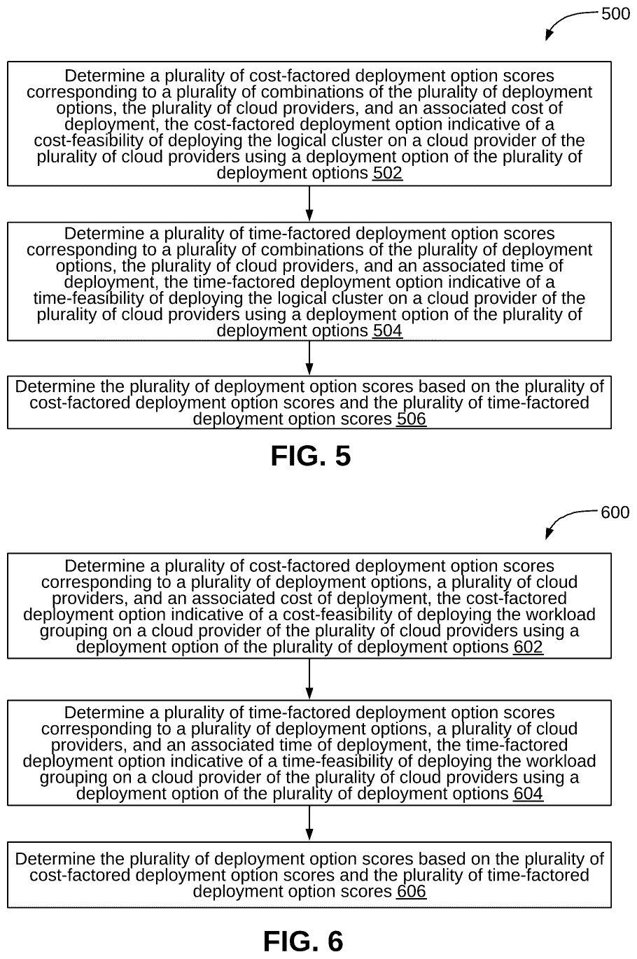

At step 306, for a logical cluster of the plurality of logical clusters, a plurality of deployment option scores corresponding to a plurality of deployment options and a plurality of cloud providers may be determined. The deployment option score may be indicative of a feasibility of deploying the logical cluster on a cloud provider of the plurality of cloud providers using a deployment option of the plurality of deployment options. The step 306 is further explained in detail in conjunction with FIG. 5.

Referring now to FIG. 5, a flowchart of a method 500 of determining the plurality of deployment option scores for a logical cluster of the plurality of logical clusters is illustrated, in accordance with some embodiments. In some embodiments, at step 502, a plurality of cost-factored deployment option scores corresponding to a plurality of combinations of the plurality of deployment options may be determined. The plurality of cloud providers, and an associated cost of deployment, the cost-factored deployment option may be indicative of a cost-feasibility of deploying the logical cluster on a cloud provider of the plurality of cloud providers using a deployment option of the plurality of deployment options. At step 504, a plurality of time-factored deployment option scores corresponding to a plurality of combinations of the plurality of deployment options are determined. The plurality of cloud providers, and an associated time of deployment, the time-factored deployment option may be indicative of a time-feasibility of deploying the logical cluster on a cloud provider of the plurality of cloud providers using a deployment option of the plurality of deployment options. At step 506, the plurality of deployment option scores may be determined based on the plurality of cost-factored deployment option scores and the plurality of time-factored deployment option scores.

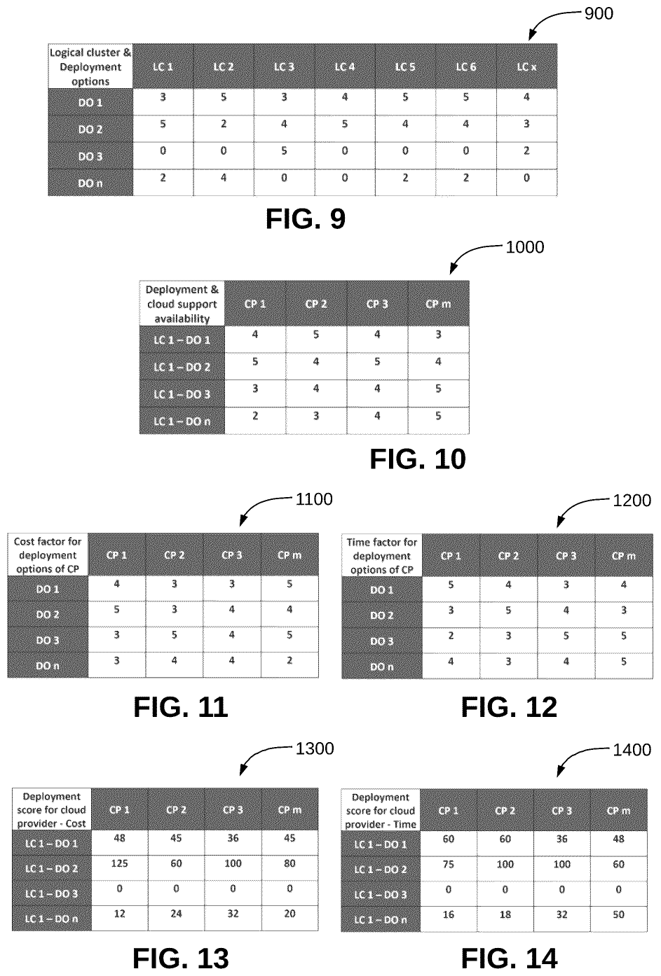

Once the logical clusters are created, then these logical clusters may be used for further scoring against cloud providers. For example, a weightage may be associated with respect to the cost factor and the time factor, to determine a final score against cloud providers. The sum of scores with respect to the cost and time weightage should be 100. As will be understood, if an environment must replicate in short time without considering cost, then the time weightage may be set as 100 and cost weightage may be set as 0. Similarly, if an environment must replicate at lowest short time without considering time, then the time weightage may be set as 0 and cost weightage may be set as 100. By way of an example, for the purpose of explanation, a cost weightage is set as 75 and time weightage is set as 25 (i.e. cost is a greater consideration than time). The score may range from 5-0, 5 signifying more relevant or more applicable or higher priority, whereas 0 signifying not relevant or not applicable or not required. To this end, various scores may be calculated as described in conjunction with FIGS. 9-14.

FIG. 9 depicts a Table 900 which includes scores with respect to logical clusters (LC) and deployment options (DO), in accordance with some exemplary embodiments. The scoring with respect to the DOs and LCs may be based on applicability or relevance of deploying LCs using various DOs. For example, a score with respect to a deployment option 1 (DO1) and a logical cluster 1 (LC1) is determined to be “3”, and a score with respect to a DO1 and a LC2 is determined to be “2”.

FIG. 10 depicts a Table 1000 which includes scores of a combination of logical clusters and deployment options (LC−DO) with respect to cloud providers (CP), in accordance with some exemplary embodiments. The scoring of combinations of CLs and DO (LC−DO) with respect to the CPs may be based on each cloud provider's ability to support a logical cluster using a deployment option. For example, a score of a LC 1 and DO 1 (LC1−DO1) with respect to a CP1 is determined to be “4”, and a score of the LC 1 and the DO 1 (LC1−DO1) with respect to a CP2 is determined to be “5”, and so on.

FIG. 11 depicts a Table 1100 which includes scores with respect to deployment options (DO) and cloud providers (CP) against a cost factor, in accordance with some exemplary embodiments. The scoring with respect to DOs and CPs against the cost factor may be based on optimized cost of DO against different CPs. In other words, the scores as included in the Table 1100 indicate cost significance of using a DO on different CPs. For example, a score with respect to DO1 and CP1 is determined to be “4”, and a score with respect to DO2 and CP1 is determined to be “5”, which indicates the combination of the DO2 and the CP1 may offer better cost optimization than the combination of the DO1 and the CP1.

FIG. 12 depicts a Table 1200 which includes scores with respect to deployment options (DO) and cloud providers (CP) against a time factor, in accordance with some exemplary embodiments. The scoring with respect to deployment options (DO) and cloud providers (CP) against the time factor may be based on optimized time of deployment option against different cloud providers. In other words, the scores as included in the Table 1200 indicate time significance of using a deployment option on different cloud providers, i.e. how quick environment of deployment option could setup against different cloud providers. For example, a score with respect to DO1 and CP1 is determined to be “5”, and a score with respect to DO2 and CP1 is determined to be “3”, which indicates the combination of the DO1 and the CP1 may offer better time optimization than the combination of the DO2 and the CP1.

FIG. 13 depicts a Table 1300 which includes scores of combinations of logical clusters and deployment options (LC-DO) with respect to cloud providers (CP) against cost factor, in accordance with some exemplary embodiments. This score, therefore, is a product of corresponding scores obtained in Table 900, 1000, 1100. As such, the score (of combination of logical cluster and deployment option (LC-DO)) may be represented as: Logical cluster & Deployment options*Deployment & cloud support availability*Cost factor for deployment options of CP.

FIG. 14 depicts a Table 1400 which includes scores of combinations of logical clusters and deployment options (LC-DO) with respect to cloud providers (CP) against time factor, in accordance with some exemplary embodiments. This score, therefore, is a product of corresponding scores obtained in Table 900, 1000, 1200. As such, the score (of combination of logical cluster and deployment option (LC-DO)) may be represented as: Logical cluster & Deployment options*Deployment & cloud support availability*Time factor for deployment options of CP.

Returning to FIG. 3, at step 308, based on the plurality of deployment option scores, for each logical cluster of the plurality of logical clusters, a cloud provider may be selected from the plurality of cloud providers on which the logical cluster is deployed, and a deployment option may be selected from the plurality of deployment options using which the logical cluster is deployed.

Alternately, in some embodiments, the method 300 may proceed to step 310 from the step 306. At step 310, based on the plurality of deployment option scores, for each logical cluster of the plurality of logical clusters, a plurality of combinations of a cloud provider may be selected from the plurality of cloud providers and a deployment option from the plurality of deployment options, on which the logical cluster is deployed. In other words, instead of selecting a single cloud provider and a single deployment option (as at step 308), combinations of a cloud provider a deployment option may be selected at step 310.

Further, in some embodiments, the method 300 may take into consideration the non-functional requirements, and accordingly, proceed to step 312 from the step 306. At step 312, for a logical cluster of the plurality of logical clusters, a plurality of non-functional requirements (NFR) scores corresponding to a plurality of combinations of a plurality of non-functional requirements (NFR) and the plurality of cloud providers (CP) may be determined. The non-functional requirements score may be indicative of a feasibility of deploying the logical cluster on a cloud provider of the cloud providers based on a non-functional requirement of the plurality of non-functional requirements.

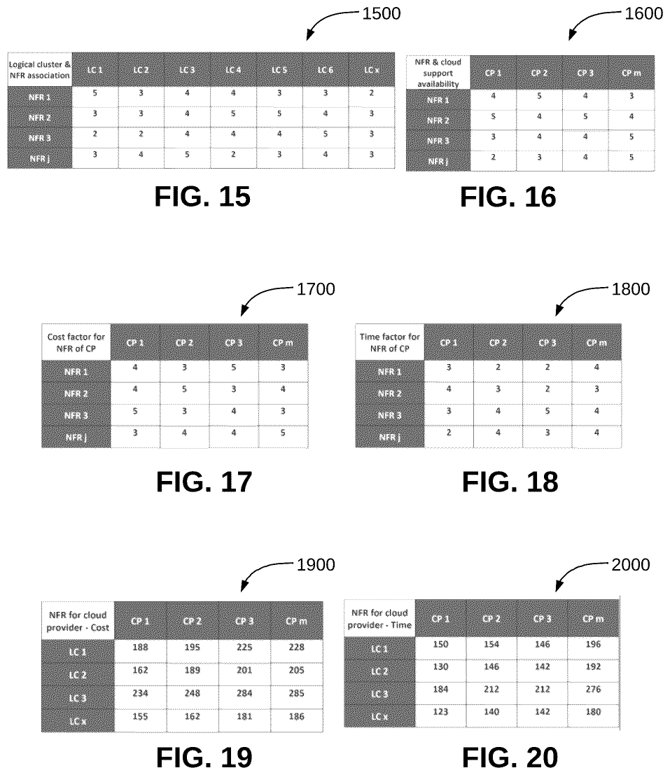

It should be noted that beyond the functional requirement, based on the nature of business, and logical cluster, various NFR requirements may also be considered along with deployment options. Hence, the support of the cloud providers for the NFRs also can be critical faction of selection. For example, in a banking workload, data security could be very critical. In order to determine the non-functional requirements scores, various scores may be calculated as described in conjunction with FIGS. 15-20.

FIG. 15 depicts a Table 1500 which includes scores with respect to logical clusters (LC) and non-functional requirements (NFR), in accordance with some exemplary embodiments. The scoring with respect to the NFRs and LCs may be based on applicability or relevance of deploying LCs using various NFRs. For example, a score with respect to a NFR 1 and a logical cluster 1 (LC1) is determined to be “5”, and a score with respect to the NFR 1 and a LC2 is determined to be “3”.

FIG. 16 depicts a Table 1600 which includes scores with respect to NFRs and cloud providers (CP), in accordance with some exemplary embodiments. The scoring with respect to the NFRs and CPs may be based on ability of the cloud provider to support a given NFR. For example, a score with respect to a NFR 1 and a CP1 is determined to be “4”, and a score with respect to the NFR 1 and a CP2 is determined to be “5”.

FIG. 17 depicts a Table 1700 which includes scores with respect to NFRs and CPs against a cost factor, in accordance with some exemplary embodiments. The scoring with respect to NFRs and CPs against the cost factor may be based on optimized cost of NFR against different CPs. In other words, the scores as included in the Table 1700 indicate cost significance of using a NFR on different CPs. For example, a score with respect to NFR 1 and CP1 is determined to be “4”, and a score with respect to the NFR 1 and a CP2 is determined to be “3”, which indicates the combination of the NFR 1 and the CP1 may offer better cost optimization than the combination of the NFR 1 and the CP2.

FIG. 18 depicts a Table 1800 which includes scores with respect to NFRs and CPs against a time factor, in accordance with some exemplary embodiments. The scoring with respect to NFRs and CPs against the time factor may be based on optimized time of NFR against different cloud providers. In other words, the scores as included in the Table 1800 indicate time significance of using a NFR on different CPs, i.e. how quick environment of NFR could setup against different cloud providers. For example, a score with respect to NFR 1 and CP1 is determined to be “3”, and a score with respect to NFR 2 and CP1 is determined to be “4”, which indicates the combination of the NFR 2 and the CP1 may offer better time optimization than the combination of the NFR 1 and the CP1.

FIG. 19 depicts a Table 1900 which includes scores with respect to LCs, the CPs, and the NFRs against the cost factor, in accordance with some exemplary embodiments. This score, therefore, is summation of association of the LCs and NFRs (Table 1600), association of the NFR and cloud support availability (CPs) (Table 1700), and association of the cost factor for NFR and CP (Table 1800). The score may be, therefore, represented as Σ((Logical cluster and NFR association)*(NFR and cloud support availability)*(Cost factor for NFR of CP)).

FIG. 20 depicts a Table 2000 which includes scores with respect to LCs, the CPs, and the NFRs against the time factor, in accordance with some exemplary embodiments. This score, therefore, is summation of association of the LCs and NFRs (Table 1600), association of the NFR and cloud support availability (CPs) (Table 1700), and association of the time factor for NFR and CP (Table 1900). The score may be, therefore, represented as Σ((Logical cluster and NFR association)*(NFR and cloud support availability)*(Time factor for NFR of CP)).

Returning to FIG. 3, therefore, the method 300 may proceed to step 314 from the step 312. At step 314, based on the plurality of non-functional requirements scores and the plurality of deployment option scores, for each logical cluster of the plurality of logical clusters, a cloud provider may be selected from the plurality of cloud providers on which the logical cluster may be deployed, a deployment option may be selected from the plurality of deployment options using which the logical cluster may be deployed, and a NFR may be selected from the plurality of NFRs using which the logical cluster may be deployed. The cloud provider may be selected based on a cost score associated with deployment of each LC in each CP and a time score associated with deployment of each LC in each CP. The cost score associated with a LC and a CP may be calculated as a mathematical product of the deployment score for cloud provider against cost factor (as determined in Table 1300) and scores with respect to a LC, a CP, and a NFR against the cost factor (as determined in Table 1900), and may be represented as below:

$$\\ cost score for LC in CP = ( deployment score for cloud provider - cost factor ) * ( NFR for cloud provider - cost factor )$$

The time score associated with a LC and a CP may be calculated as a mathematical product of the deployment score for cloud provider against time factor (as determined in Table 1400) and scores with respect to a LC, a CP, and a NFR against the time factor (as determined in Table 2000), and may be represented as below:

$$\\ time score for LC in CP = ( deployment score for cloud provider - time factor ) * ( NFR for cloud provider - time factor )$$

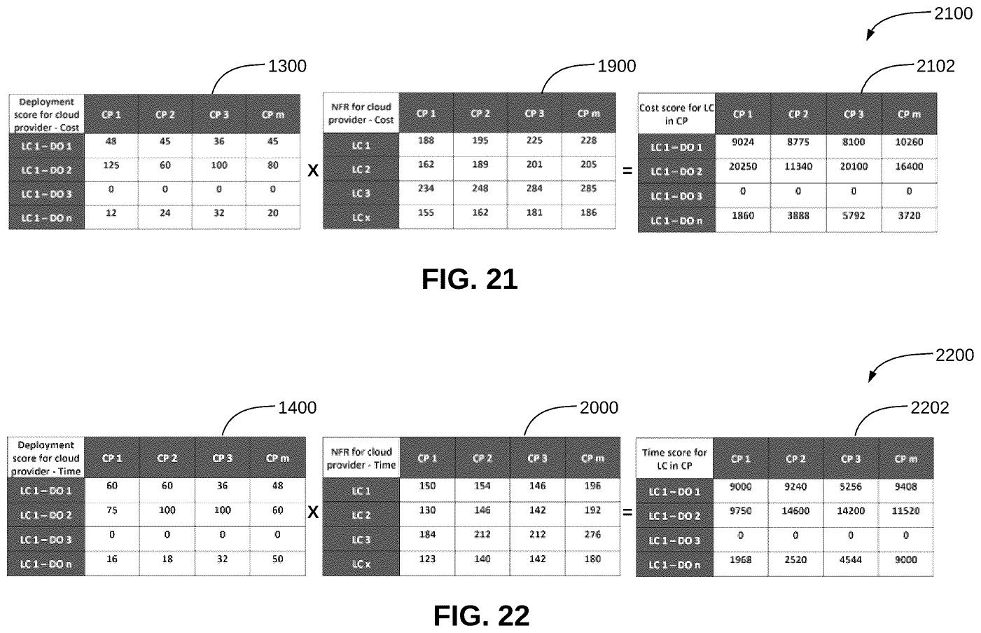

The calculation of the above the cost score for LC in CP and the time score for LC in CP is represented via the FIGS. 21-22. FIG. 21 depicts an exemplary process 2100 of calculating the cost score for LC in CP based on the mathematical product of the deployment score for cloud provider against cost factor (as determined in Table 1300) and scores with respect to a LC, a CP, and a NFR against the cost factor (as determined in Table 1900). The calculated cost scores for various LCs in various CPs is depicted in the Table 2102. FIG. 22 depicts an exemplary process of the calculating the time score for LC in CP based on the mathematical product of the deployment score for cloud provider against time factor (as determined in Table 1400) and scores with respect to a LC, a CP, and a NFR against the time factor (as determined in Table 2000). The calculated cost scores for various LCs in various CPs is depicted in the Table 2202. As such, a score is calculated for a logical cluster considering various deployment option and non-functional requirements associated scores, and similarly the process is repeated to calculate the score for different combinations of logical clusters, deployment options, and NFRs.

Based on the calculation performed in conjunction with FIGS. 21-22, the cloud provider with highest score for a logical cluster may be recommended for individual deployment of the said logical cluster. For example, for LC 1, the recommendation may be for deploying the LC 1 using DO 2 in the CP 1 considering the cost factor. In the same way, the recommendation for the LC 1 may be for deploying it using DO 2 in the CP 2 considering the time factor.

Therefore, once the scores for cost and time for each of the logical clusters against cloud providers are calculated individually, a final score for the logical cluster against a cloud provider may be calculated, to determine which cloud provider is suitable with which deployment option, for the said logical cluster. As such, the final score may be calculated as sum of the associated score for cost along with the cost weightage and the associated score for time along with the time weightage, and represented as below:

$$\\ Final LC DC in CP score = ( cost factor weightage * LC DO cost score ) + ( time factor weightage * LC DO time score )$$

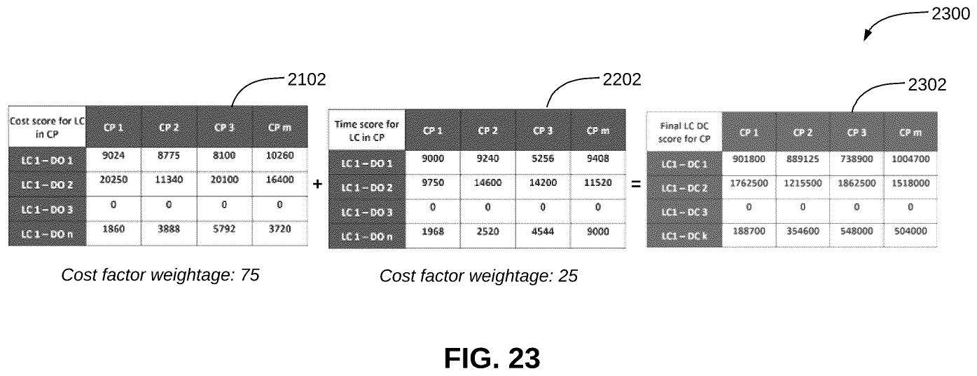

For example, a cost factor weightage may be predefined as 75, and a time factor weightage may be predefined as 25. Accordingly, the final score with respect to logical cluster and deployment option against a cloud provider may be calculated, as is shown via process of 2300 in FIG. 23. FIG. 23 depicts the process of calculating the final score with respect to logical cluster and deployment option against a cloud provider, based on the cost scores for various LCs in various CPs as calculated via the process 2100 (FIG. 21), the time scores calculated for various LCs in various CPs as calculated via the process 2200 (FIG. 22), the cost factor weightage, and time factor weightage.

### Workload Grouping of Logical Clusters:

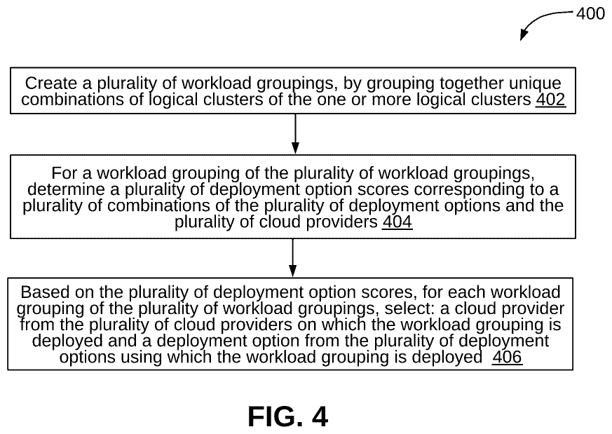

In some embodiments, the selection of the cloud provider and/or the deployment option for deploying the logical cluster may be further based on analysis of workload groupings. This is explained in detail conjunction with FIG. 4.

Referring now to FIG. 4, a method 400 of determining plurality of deployment option scores for a workload grouping of the plurality of workload groupings is illustrated, in accordance with some embodiments.

In some embodiments, at step 402, a plurality of workload groupings may be created, by grouping together unique combinations of logical clusters of the one or more logical clusters. It should be noted that while logical cluster is an individually deployable group of resources, a workload grouping may be a group of all the required logical clusters which could include all the components to recreate an existing environment.

At step 404, for a workload grouping of the plurality of workload groupings, a plurality of deployment option scores corresponding to a plurality of combinations of the plurality of deployment options and the plurality of cloud providers may be determined. This deployment option may be score indicative of a feasibility of deploying the workload grouping on a cloud provider of the plurality of cloud providers using a deployment option of the plurality of deployment options. Determining the plurality of deployment option scores for a workload grouping of the plurality of workload groupings is further explained on conjunction with FIG. 6.

Referring now to FIG. 6, a flowchart of a method 600 of determining the plurality of deployment option scores for a workload grouping of the plurality of workload groupings is illustrated, in accordance with some embodiments. At step 602, a plurality of cost-factored deployment option scores corresponding to a plurality of deployment options, a plurality of cloud providers, and an associated cost of deployment may be dethroned. The cost-factored deployment option may be indicative of a cost-feasibility of deploying the workload grouping on a cloud provider of the plurality of cloud providers using a deployment option of the plurality of deployment options. At step 604, a plurality of time-factored deployment option scores corresponding to a plurality of deployment options, a plurality of cloud providers, and an associated time of deployment may be determined. The time-factored deployment option score may be indicative of a time-feasibility of deploying the workload grouping on a cloud provider of the plurality of cloud providers using a deployment option of the plurality of deployment options. At step 606, the plurality of deployment option scores may be determined based on the plurality of cost-factored deployment option scores and the plurality of time-factored deployment option scores. This score for workload grouping may be calculated using the scores calculated for each of the logical clusters with deployment options and NFR, as discussed in the previous sections of this disclosure (refer, FIGS. 9-22).

For the purpose of explanation, by way of an example, two workload groupings may be considered, viz. a workload group WLG1 and a workload group WLG2, such that:
workload group WLG1 includes logical cluster 1, logical cluster 2, logical cluster 3, and logical cluster 4; and
workload group WLG2 may include logical cluster 1, logical cluster 2, logical cluster 3, and logical cluster 5, logical cluster 6, and logical cluster x.

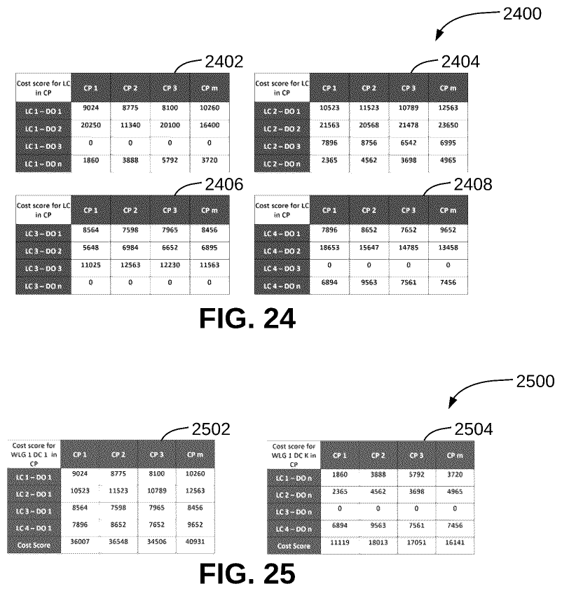

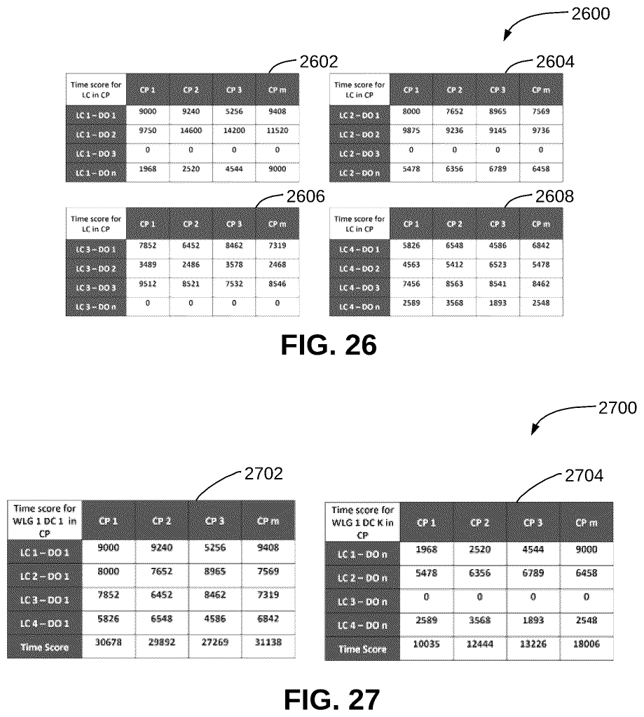

A workload group level cost score for a deployment combination (WLG 1-DC) may be calculated as sum of scores for deployment combination of the LC and DO for the various CPs. If there are ‘k’ numbers of logical clusters in a workload group and ‘n’ deployment options, then, there will be “k*n” number of workload group level combinations for single cloud provider (CP). Similarly, time scores for a deployment combination (WLG1-DC) may be calculated as well. For example, the calculation of cost-factored deployment option scores associated with the workload grouping 1 (WLG 1) is shown in FIG. 24, via Tables 2402, 2404, 2406, 2408. The calculation of cost-factored deployment option scores associated with the workload grouping 2 (WLG 2) is shown in FIG. 25, via Tables 2502, 2504. The calculation of time-factored deployment option scores associated with the workload grouping 1 (WLG 1) is shown in FIG. 26, via Tables 2602, 2604, 2606, 2608. The calculation of time-factored deployment option scores associated with the workload grouping 2 (WLG 2) is shown in FIG. 27, via Tables 2702, 2704.

A final score for the workload group against the cloud providers can be calculated using the below formula:

$$\\ Final WLG DC in CP score = ( cost weightage * WLG DC cost score ) + ( time weightage * WLG DC time score )$$

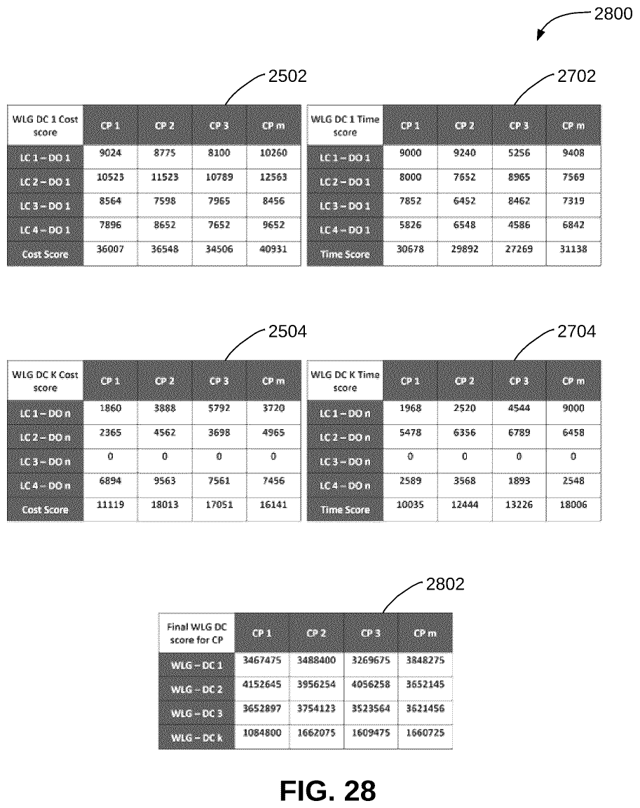

For example, a cost factor weightage may be predefined as 75, and a time factor weightage may be predefined as 25. Accordingly, the final score with respect to workload group and deployment option against a cloud provider may be calculated, as is shown via process of 2800 in FIG. 28. FIG. 28 depicts the process 2800 of calculating the final score with respect to workload grouping and deployment option against a cloud provider, based on the cost scores for various WLGs in various CPs as calculated via processes 2400, 2500 (Table 2502, 2504; FIG. 25), the time scores calculated for various WLGs in various CPs as calculated via processes 2600, 2700 (Table 2702, 2704; FIG. 27), the cost factor weightage, and time factor weightage.

Referring back to FIG. 4, at step 406, based on the plurality of deployment option scores, for each workload grouping of the plurality of workload groupings, a cloud provider may be selected from the plurality of cloud providers on which the workload grouping may be deployed and a deployment option may be selected from the plurality of deployment options using which the workload grouping may be deployed.

It should be noted that, in some embodiments, the resource deployment may either be based on single cloud deployment or multi cloud deployment.

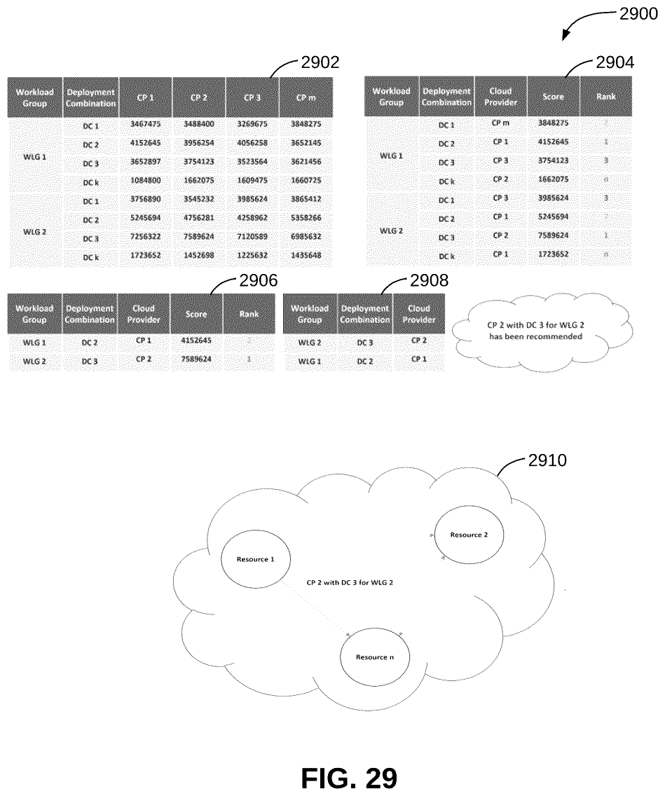

In single cloud deployment (i.e. step 308, FIG. 3) all required resources/services may be deployed on a single cloud provider. As such, for identifying the best suitable cloud provider, scoring report of workload group and deployment combination may be used. An example process of single cloud provider deployment is illustrated via FIG. 29.

Referring now to FIG. 29, the scores of different workload grouping with possible deployment combinations against cloud provider may be analyzed, as shown in Table 2902. Further, based on the analysis of the scores of different workload grouping with possible deployment combinations against cloud providers, a ranking is obtained as shown in Table 2904. The cloud providers getting higher score for each workload grouping and deployment combination may be filtered out and then compared within themselves for ranking. The high scoring combinations of cloud provider and deployment combination of workload group may be compared against each other, to finalize which cloud provider may be selected for creating the ideal target environment, as shown in Table 2906, 2908. Accordingly, in the given example, for WLG 2, CP2 with DC 3 may be recommended. As such, all the resources associated with the WLG 2 may be deployed on a single cloud provider, as shown in schematic representation 2910 of the cloud provider 2 (CP2).

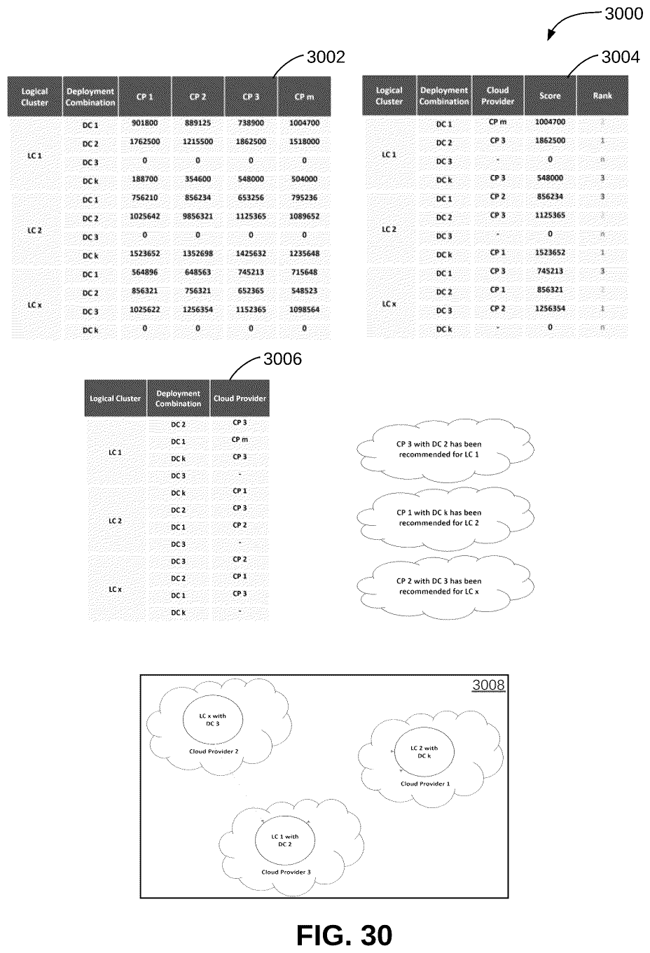

Alternately, in some embodiments, the resource deployment may be based on multi cloud deployment (i.e. step 310, FIG. 3). In the multi cloud deployment, the workload grouping may not be considered. Instead, the comparison and recommendation may be performed based on the logical cluster scoring. An example process of multi cloud provider deployment is illustrated via FIG. 30.

Referring now to FIG. 30, for deploying resources on multi cloud environment, logical cluster scoring may be used. Each logical cluster of a workload grouping may be analyzed for possible deployment options against cloud providers, as shown in Table 3002. Based on the analyzed, a ranking may be obtained for each of available logical cluster, as shown in Table 3004. Cloud providers. Cloud providers with higher score for each logical cluster and deployment combination may be filtered out and then compared within themselves for ranking to finalize ideal target environment, as shown in Table 3006. As such, various possible combinations of cloud providers (CPs) with deployment combinations (DC) may be recommended for each logical cluster (LC). For example, as shown in schematic representation 3008, for the logical clusters of the WLG 2 (of FIG. 29), following recommendations may be made:
for LC1, CP3 and DC2 may be recommended;
for LC2, CP1 and DCk may be recommended; and
for LCx, CP2 and DC3 may be recommended.

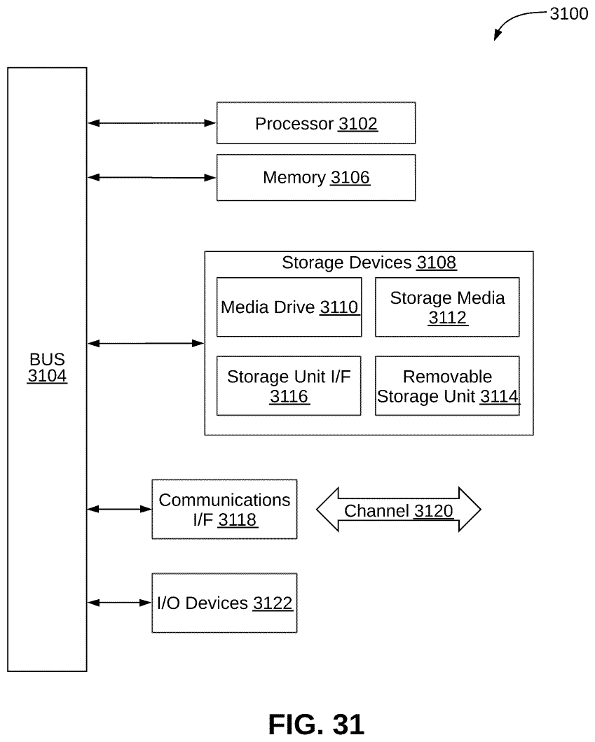

Referring now to FIG. 31, an exemplary computing system 3100 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 3100 may represent, for example, a user device such as a desktop, a laptop, a mobile phone, personal entertainment device, DVR, and so on, or any other type of special or general-purpose computing device as may be desirable or appropriate for a given application or environment. The computing system 3100 may include one or more processors, such as a processor 3102 that may be implemented using a general or special purpose processing engine such as, for example, a microprocessor, microcontroller or other control logic. In this example, the processor 3102 is connected to a bus 3104 or other communication media. In some embodiments, the processor 3102 may be an Artificial Intelligence (AI) processor, which may be implemented as a Tensor Processing Unit (TPU), or a graphical processor unit, or a custom programmable solution Field-Programmable Gate Array (FPGA).

The computing system 3100 may also include a memory 3106 (main memory), for example, Random Access Memory (RAM) or other dynamic memory, for storing information and instructions to be executed by the processor 3102. The memory 3106 also may be used for storing temporary variables or other intermediate information during the execution of instructions to be executed by processor 3102. The computing system 3100 may likewise include a read-only memory (“ROM”) or other static storage device coupled to bus 3104 for storing static information and instructions for the processor 3102.

The computing system 3100 may also include storage devices 3108, which may include, for example, a media drive 3110 and a removable storage interface. The media drive 3110 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 3112 may include, for example, a hard disk, magnetic tape, flash drive, or other fixed or removable media that is read by and written to by the media drive 3110. As these examples illustrate, the storage media 3112 may include a computer-readable storage medium having stored therein particular computer software or data.

In alternative embodiments, the storage devices 3108 may include other similar instrumentalities for allowing computer programs or other instructions or data to be loaded into the computing system 3100. Such instrumentalities may include, for example, a removable storage unit 3114 and a storage unit interface 3116, such as a program cartridge and cartridge interface, a removable memory (for example, a flash memory or other removable memory module) and memory slot, and other removable storage units and interfaces that allow software and data to be transferred from the removable storage unit 3114 to the computing system 3100.

The computing system 3100 may also include a communications interface 3118. The communications interface 3118 may be used to allow software and data to be transferred between the computing system 3100 and external devices. Examples of the communications interface 3118 may include a network interface (such as an Ethernet or other NIC card), a communications port (such as for example, a USB port, a micro-USB port), Near field Communication (NFC), etc. Software and data transferred via the communications interface 3118 are in the form of signals which may be electronic, electromagnetic, optical, or other signals capable of being received by the communications interface 3118. These signals are provided to the communications interface 3118 via a channel 3120. The channel 3120 may carry signals and may be implemented using a wireless medium, wire or cable, fiber optics, or other communications medium. Some examples of the channel 3120 may include a phone line, a cellular phone link, an RF link, a Bluetooth link, a network interface, a local or wide area network, and other communications channels.

The computing system 3100 may further include Input/Output (I/O) devices 3122. Examples may include, but are not limited to a display, keypad, microphone, audio speakers, vibrating motor, LED lights, etc. The I/O devices 3122 may receive input from a user and also display an output of the computation performed by the processor 3102. In this document, the terms “computer program product” and “computer-readable medium” may be used generally to refer to media such as, for example, the memory 3106, the storage devices 3108, the removable storage unit 3114, or signal(s) on the channel 3120. These and other forms of computer-readable media may be involved in providing one or more sequences of one or more instructions to the processor 3102 for execution. Such instructions, generally referred to as “computer program code” (which may be grouped in the form of computer programs or other groupings), when executed, enable the computing system 3100 to perform features or functions of embodiments of the present invention.

In an embodiment where the elements are implemented using software, the software may be stored in a computer-readable medium and loaded into the computing system 3100 using, for example, the removable storage unit 3114, the media drive 3110 or the communications interface 3118. The control logic (in this example, software instructions or computer program code), when executed by the processor 3102, causes the processor 3102 to perform the functions of the invention as described herein.

One or more techniques for optimized deployment of the resources on one or more cloud providers are disclosed above. The above techniques allow for analyzing an environment and provide business-specific recommendations that help to rightly utilize the cloud configuration for better sustainability and optimal cost, thereby addition value to the business. As such, the techniques decrease utilization cost and increases profit, increase adaptation capabilities, improves customer experience, avoid creating wrong or unwanted resources, and avoid oversizing of resources.

It is intended that the disclosure and examples be considered as exemplary only, with a true scope and spirit of disclosed embodiments being indicated by the following claims.

What is claimed is:

1. A method of optimized deployment of resources on cloud providers, the method comprising:
determining an inter-relationship score for a relationship of each of a plurality of resources with each of remaining of the plurality of resources, based on attributes associated with each of the plurality of resources;
creating one or more logical clusters of resources, by clustering together resources based on the inter-relationship score for relationship of each of the plurality of resources with each of remaining of the plurality of resources,
each of the one or more logical clusters comprising a set of resources of the plurality of resources;
for a logical cluster of the plurality of logical clusters, determining a plurality of deployment option scores corresponding to a plurality of deployment options and a plurality of cloud providers, the deployment option score indicative of a feasibility of deploying the logical cluster on a cloud provider of the plurality of cloud providers using a deployment option of the plurality of deployment options; and
based on the plurality of deployment option scores, for each logical cluster of the plurality of logical clusters, selecting:
a cloud provider from the plurality of cloud providers on which the logical cluster is deployed; and
a deployment option from the plurality of deployment options using which the logical cluster is deployed.

2. The method of claim 1,
wherein the plurality of deployment options comprise: a virtual machine (VM) deployment, a container deployment, a Kubernetes deployment, a Managed Service deployment, and a Serverless deployment, and
wherein the plurality of resources comprise: a runtime, a server, a RDBMS, a NoSQL, a dashboarding, and a service.

3. The method of claim 1, wherein determining the plurality of deployment option scores for a logical cluster of the plurality of logical clusters comprises:
determining a plurality of cost-factored deployment option scores corresponding to a plurality of combinations of the plurality of deployment options, the plurality of cloud providers, and an associated cost of deployment, the cost-factored deployment option indicative of a cost-feasibility of deploying the logical cluster on a cloud provider of the plurality of cloud providers using a deployment option of the plurality of deployment options;
determining a plurality of time-factored deployment option scores corresponding to a plurality of combinations of the plurality of deployment options, the plurality of cloud providers, and an associated time of deployment, the time-factored deployment option indicative of a time-feasibility of deploying the logical cluster on a cloud provider of the plurality of cloud providers using a deployment option of the plurality of deployment options; and
determining the plurality of deployment option scores based on the plurality of cost-factored deployment option scores and the plurality of time-factored deployment option scores.

4. The method of claim 1 further comprising:
for a logical cluster of the plurality of logical clusters, determining a plurality of non-functional requirements scores corresponding to a plurality of combinations of a plurality of non-functional requirements and the plurality of cloud providers, the non-functional requirements score indicative of a feasibility of deploying the logical cluster on a cloud provider of the cloud providers based on a non-functional requirement of the plurality of non-functional requirements; and
based on the plurality of non-functional requirements scores and the plurality of deployment option scores, for each logical cluster of the plurality of logical clusters, selecting:
a cloud provider from the plurality of cloud providers on which the logical cluster is deployed;
a deployment option from the plurality of deployment options using which the logical cluster is deployed; and
a non-functional requirement from the plurality of non-functional requirements using which the logical cluster is deployed.

5. The method of claim 4, wherein the plurality of non-functional requirements comprise: a scalability requirement, a security requirement, an availability requirement, a reliability requirement, a performance requirement, a monitoring-and-alerting requirement.

6. The method of claim 1, further comprising:
based on the plurality of deployment option scores, for each logical cluster of the plurality of logical clusters, selecting:
a plurality of combinations of a cloud provider from the plurality of cloud providers and a deployment option from the plurality of deployment options, on which the logical cluster is deployed.

7. The method of claim 1, further comprising:
creating a plurality of workload groupings, by grouping together unique combinations of logical clusters of the one or more logical clusters;
for a workload grouping of the plurality of workload groupings, determining a plurality of deployment option scores corresponding to a plurality of combinations of the plurality of deployment options and the plurality of cloud providers, the deployment option score indicative of a feasibility of deploying the workload grouping on a cloud provider of the plurality of cloud providers using a deployment option of the plurality of deployment options; and
based on the plurality of deployment option scores, for each workload grouping of the plurality of workload groupings, selecting:
a cloud provider from the plurality of cloud providers on which the workload grouping is deployed; and
a deployment option from the plurality of deployment options using which the workload grouping is deployed.

8. The method of claim 7, wherein determining the plurality of deployment option scores for a workload grouping of the plurality of workload groupings comprises:
determining a plurality of cost-factored deployment option scores corresponding to a plurality of deployment options, a plurality of cloud providers, and an associated cost of deployment, the cost-factored deployment option score indicative of a cost-feasibility of deploying the workload grouping on a cloud provider of the plurality of cloud providers using a deployment option of the plurality of deployment options;
determining a plurality of time-factored deployment option scores corresponding to a plurality of deployment options, a plurality of cloud providers, and an associated time of deployment, the time-factored deployment option score indicative of a time-feasibility of deploying the workload grouping on a cloud provider of the plurality of cloud providers using a deployment option of the plurality of deployment options; and
determining the plurality of deployment option scores based on the plurality of cost-factored deployment option scores and the plurality of time-factored deployment option scores.

9. A system for optimized deployment of resources on cloud providers, the system comprising:
a processor; and
a memory communicatively coupled to the processor, wherein the memory stores a plurality of instructions, which upon execution by the processor, cause the processor to:
determine an inter-relationship score for a relationship of each of a plurality of resources with each of remaining of the plurality of resources, based on attributes associated with each of the plurality of resources;
create one or more logical clusters of resources, by clustering together resources based on the inter-relationship score for relationship of each of the plurality of resources with each of remaining of the plurality of resources,
each of the one or more logical clusters comprising a set of resources of the plurality of resources;
for a logical cluster of the plurality of logical clusters, determine a plurality of deployment option scores corresponding to a plurality of deployment options and a plurality of cloud providers, the deployment option score indicative of a feasibility of deploying the logical cluster on a cloud provider of the plurality of cloud providers using a deployment option of the plurality of deployment options; and
based on the plurality of deployment option scores, for each logical cluster of the plurality of logical clusters, select:
a cloud provider from the plurality of cloud providers on which the logical cluster is deployed; and
a deployment option from the plurality of deployment options using which the logical cluster is deployed.

10. The system of claim 9, wherein determining the plurality of deployment option scores for a logical cluster of the plurality of logical clusters comprises:
determining a plurality of cost-factored deployment option scores corresponding to a plurality of combinations of the plurality of deployment options, the plurality of cloud providers, and an associated cost of deployment, the cost-factored deployment option indicative of a cost-feasibility of deploying the logical cluster on a cloud provider of the plurality of cloud providers using a deployment option of the plurality of deployment options;
determining a plurality of time-factored deployment option scores corresponding to a plurality of combinations of the plurality of deployment options, the plurality of cloud providers, and an associated time of deployment, the time-factored deployment option indicative of a time-feasibility of deploying the logical cluster on a cloud provider of the plurality of cloud providers using a deployment option of the plurality of deployment options; and
determining the plurality of deployment option scores based on the plurality of cost-factored deployment option scores and the plurality of time-factored deployment option scores.

11. The system of claim 9, wherein the processor instructions further cause the processor to:
for a logical cluster of the plurality of logical clusters, determine a plurality of non-functional requirements scores corresponding to a plurality of combinations of a plurality of non-functional requirements and the plurality of cloud providers, the non-functional requirements score indicative of a feasibility of deploying the logical cluster on a cloud provider of the cloud providers based on a non-functional requirement of the plurality of non-functional requirements,
wherein the plurality of non-functional requirements comprise: a scalability requirement, a security requirement, an availability requirement, a reliability requirement, a performance requirement, a monitoring-and-alerting requirement;
based on the plurality of non-functional requirements scores and the plurality of deployment option scores, for each logical cluster of the plurality of logical clusters, select:
a cloud provider from the plurality of cloud providers on which the logical cluster is deployed;
a deployment option from the plurality of deployment options using which the logical cluster is deployed; and
a non-functional requirement from the plurality of non-functional requirements using which the logical cluster is deployed.

12. The system of claim 9, wherein the processor instructions further cause the processor to:
create a plurality of workload groupings, by grouping together unique combinations of logical clusters of the one or more logical clusters;
for a workload grouping of the plurality of workload groupings, determine a plurality of deployment option scores corresponding to a plurality of combinations of the plurality of deployment options and the plurality of cloud providers, the deployment option score indicative of a feasibility of deploying the workload grouping on a cloud provider of the plurality of cloud providers using a deployment option of the plurality of deployment options; and
based on the plurality of deployment option scores, for each workload grouping of the plurality of workload groupings, select:
a cloud provider from the plurality of cloud providers on which the workload grouping is deployed; and
a deployment option from the plurality of deployment options using which the workload grouping is deployed,
wherein determining the plurality of deployment option scores for a workload grouping of the plurality of workload groupings comprises:
determining a plurality of cost-factored deployment option scores corresponding to a plurality of deployment options, a plurality of cloud providers, and an associated cost of deployment, the cost-factored deployment option indicative of a cost-feasibility of deploying the workload grouping on a cloud provider of the plurality of cloud providers using a deployment option of the plurality of deployment options;
determining a plurality of time-factored deployment option scores corresponding to a plurality of deployment options, a plurality of cloud providers, and an associated time of deployment, the time-factored deployment option indicative of a time-feasibility of deploying the workload grouping on a cloud provider of the plurality of cloud providers using a deployment option of the plurality of deployment options; and
determining the plurality of deployment option scores based on the plurality of cost-factored deployment option scores and the plurality of time-factored deployment option scores.

13. A non-transitory computer-readable medium storing computer-executable instructions for optimized deployment of resources on cloud providers, the computer-executable instructions configured for:
determining an inter-relationship score for a relationship of each of a plurality of resources with each of remaining of the plurality of resources, based on attributes associated with each of the plurality of resources;
creating one or more logical clusters of resources, by clustering together resources based on the inter-relationship score for relationship of each of the plurality of resources with each of remaining of the plurality of resources,
each of the one or more logical clusters comprising a set of resources of the plurality of resources;
for a logical cluster of the plurality of logical clusters, determining a plurality of deployment option scores corresponding to a plurality of deployment options and a plurality of cloud providers, the deployment option score indicative of a feasibility of deploying the logical cluster on a cloud provider of the plurality of cloud providers using a deployment option of the plurality of deployment options; and
based on the plurality of deployment option scores, for each logical cluster of the plurality of logical clusters, selecting:
a cloud provider from the plurality of cloud providers on which the logical cluster is deployed; and
a deployment option from the plurality of deployment options using which the logical cluster is deployed.

14. The non-transitory computer-readable medium of claim 13, wherein determining the plurality of deployment option scores for a logical cluster of the plurality of logical clusters comprises:
determining a plurality of cost-factored deployment option scores corresponding to a plurality of combinations of the plurality of deployment options, the plurality of cloud providers, and an associated cost of deployment, the cost-factored deployment option indicative of a cost-feasibility of deploying the logical cluster on a cloud provider of the plurality of cloud providers using a deployment option of the plurality of deployment options;
determining a plurality of time-factored deployment option scores corresponding to a plurality of combinations of the plurality of deployment options, the plurality of cloud providers, and an associated time of deployment, the time-factored deployment option indicative of a time-feasibility of deploying the logical cluster on a cloud provider of the plurality of cloud providers using a deployment option of the plurality of deployment options; and
determining the plurality of deployment option scores based on the plurality of cost-factored deployment option scores and the plurality of time-factored deployment option scores.

15. The non-transitory computer-readable medium of claim 13, wherein the computer-executable instructions are further configured for:
for a logical cluster of the plurality of logical clusters, determining a plurality of non-functional requirements scores corresponding to a plurality of combinations of a plurality of non-functional requirements and the plurality of cloud providers, the non-functional requirements score indicative of a feasibility of deploying the logical cluster on a cloud provider of the cloud providers based on a non-functional requirement of the plurality of non-functional requirements,
wherein the plurality of non-functional requirements comprise: a scalability requirement, a security requirement, an availability requirement, a reliability requirement, a performance requirement, a monitoring-and-alerting requirement;
based on the plurality of non-functional requirements scores and the plurality of deployment option scores, for each logical cluster of the plurality of logical clusters, selecting:
a cloud provider from the plurality of cloud providers on which the logical cluster is deployed;
a deployment option from the plurality of deployment options using which the logical cluster is deployed; and
a non-functional requirement from the plurality of non-functional requirements using which the logical cluster is deployed.

16. The non-transitory computer-readable medium of claim 13, wherein the computer-executable instructions are further configured for:
creating a plurality of workload groupings, by grouping together unique combinations of logical clusters of the one or more logical clusters;
for a workload grouping of the plurality of workload groupings, determining a plurality of deployment option scores corresponding to a plurality of combinations of the plurality of deployment options and the plurality of cloud providers, the deployment option score indicative of a feasibility of deploying the workload grouping on a cloud provider of the plurality of cloud providers using a deployment option of the plurality of deployment options; and
based on the plurality of deployment option scores, for each workload grouping of the plurality of workload groupings, selecting:
a cloud provider from the plurality of cloud providers on which the workload grouping is deployed; and
a deployment option from the plurality of deployment options using which the workload grouping is deployed,
wherein determining the plurality of deployment option scores for a workload grouping of the plurality of workload groupings comprises:
determining a plurality of cost-factored deployment option scores corresponding to a plurality of deployment options, a plurality of cloud providers, and an associated cost of deployment, the cost-factored deployment option indicative of a cost-feasibility of deploying the workload grouping on a cloud provider of the plurality of cloud providers using a deployment option of the plurality of deployment options;
determining a plurality of time-factored deployment option scores corresponding to a plurality of deployment options, a plurality of cloud providers, and an associated time of deployment, the time-factored deployment option indicative of a time-feasibility of deploying the workload grouping on a cloud provider of the plurality of cloud providers using a deployment option of the plurality of deployment options; and
determining the plurality of deployment option scores based on the plurality of cost-factored deployment option scores and the plurality of time-factored deployment option scores.
